(19) United States
(12) Patent Application Publication
(10) Pub. No.: US 2023/0385087 A1
(43) Pub. Date: Nov. 30, 2023

(54) CLICKSTREAM PROCESSING FOR INTELLIGENT ROUTING

(71) Applicant: INTUIT INC., Mountain View, CA (US)

(72) Inventors: Tomer TAL, Mountain View, CA (US); Prarit LAMBA, San Diego, CA (US); Clifford Green, San Diego, CA (US); Xiaoyu ZENG, Mountain View, CA (US); Neo YUCHEN, Mountain View, CA (US); Andrew MATTARELLA-MICKE, Mountain View, CA (US)

(73) Assignee: INTUIT INC., Mountain View, CA (US)

(21) Appl. No.: 17/804,828

(22) Filed: May 31, 2022

(51) Int. Cl. G06F 9/451; G06N 20/00; G06F 11/34; G06F 3/04842

(52) U.S. Cl. CPC G06F 9/453; G06N 20/00; G06F 11/3438; G06F 3/04842

(57) ABSTRACT

A processor may obtain historic clickstream data indicating a plurality of interactions with a user interface (UI) by a plurality of users. The processor may select at least one user for real-time monitoring by processing, using a machine learning (ML) model, the historic clickstream data and at least one user feature and predicting, from the processing, that the at least one user will utilize a UI resource. The processor may monitor ongoing clickstream data of the selected at least one user and configure the UI resource according to the ongoing clickstream data.

### BACKGROUND

Software user interfaces (UIs) often attempt to provide customized experiences to users. For example, some users may be more interested in UI-based help presentations, while others may be uninterested in viewing such information and may prefer figuring out how to use the software on their own. Tailoring a UI to a user's needs and preferences can not only improve the user experience and increase user satisfaction, but also can provide processing efficiencies (e.g., not requiring rendering and presentation of superfluous data). However, anticipating a user's needs and preferences is not always straightforward. Attempts to do so can be based on evidence available to systems employing UIs. For example, clickstream data, which is a record of interactions by a user or users with the UI, may be a potential source of evidence that can be used to customize UI presentations.

### BRIEF DESCRIPTIONS OF THE DRAWINGS

FIG. 1 shows an example processing system according to some embodiments of the disclosure.

FIG. 2 shows an example training process according to some embodiments of the disclosure.

FIG. 3 shows an example processing decision process according to some embodiments of the disclosure.

FIG. 4 shows an example real-time configuration process according to some embodiments of the disclosure.

FIG. 5 shows a computing device according to some embodiments of the disclosure.

### DETAILED DESCRIPTION OF SEVERAL EMBODIMENTS

Embodiments described herein can use clickstream data to configure UI resources to a context that is relevant to a user of the UI before the user selects the UI resources. For example, clickstream data can be used to determine what help topics a user may need in a self-help interface and make those topics available instantly when the user asks for help. However, many computing systems have low latency requirements (e.g., ˜4 seconds between a clickstream event and a model returning a prediction), high transaction volumes (high throughput per second (TPS)), and strong seasonality of user traffic. These characteristics pose significant challenges to real-time inference data infrastructures that process clickstream data with preconfigured resources. Accordingly, embodiments described herein include techniques to reduce processing overhead and improve response time by selectively identifying users most likely to need customizable UI resources and prioritizing their data for real-time analysis.

For example, a processor can obtain historic clickstream data from multiple users' UI interactions. The processor can identify at least one user for real-time monitoring by processing, using a machine learning (ML) model, the historic clickstream data and at least one user feature and predicting that the at least one user will utilize a UI resource such as online self-help services. The processor can monitor ongoing clickstream data of the selected user and configure the UI resource according to the ongoing clickstream data.

In this example and/or other embodiments, the hotspot identification model disclosed herein can predict the users who are most likely to engage with self-help. This customer segmentation can be generalized for other use cases, such as anticipating user escalation and upselling products. The customer segmentation can also facilitate customer feature enrichment that helps future model use cases, such as identifying which users are most likely to invoke other predictive models downstream.

The disclosed embodiments can provide technical improvements and benefit individual users by providing a better user experience. For example, the disclosed ML components can streamline the launch of new user-customized UI features by leveraging preexisting trained models. The disclosed embodiments can potentially reduce data infrastructure needs by reducing the traffic to under 10% of comparable traffic volume without hotspot identification, which also reduces maintenance costs and the likelihood of system downtime caused by unexpected traffic spikes. The disclosed embodiments provide faster content processing time relative to comparable techniques without hotspot identification, which is both a technical and user experience benefit. Furthermore, users who are most likely to need UI resources can be identified, which can benefit subsequent routing processing as well as allow for a better-curated user experience (e.g., providing more relevant content to the user through the UI).

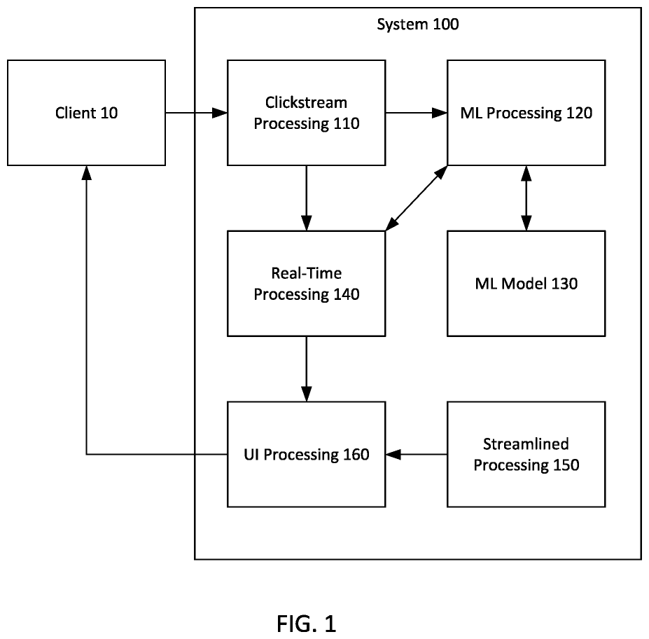

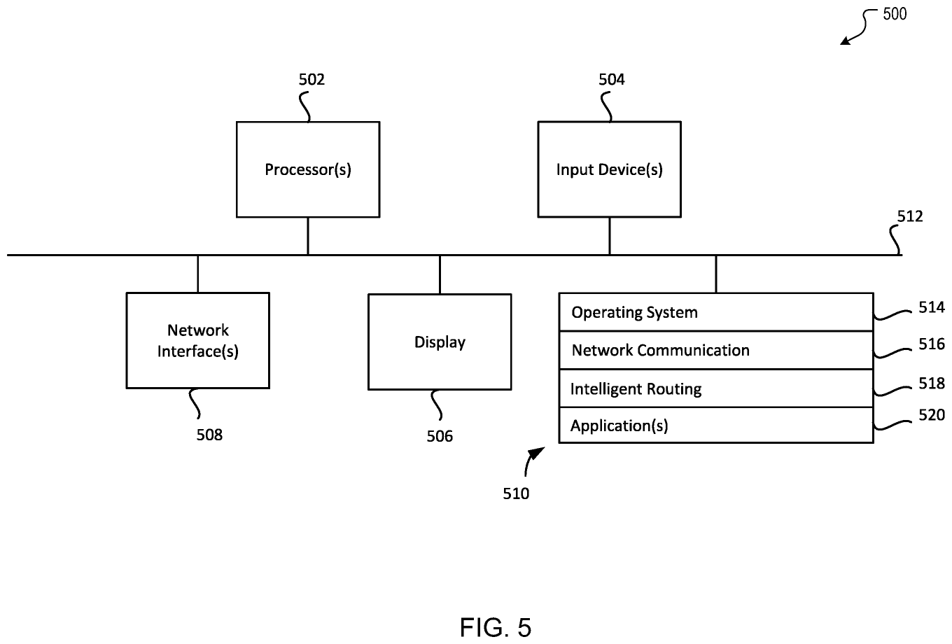

FIG. 1 shows an example processing system 110 according to some embodiments of the disclosure. System 110 may include a variety of hardware, firmware, and/or software components that interact with one another. Some components may communicate with client(s) 10 through a network (e.g., the Internet, an intranet, and/or one or more networks that provide a cloud environment). Some components may communicate with one another using network 100. Each component may be implemented by one or more computers (e.g., as described below with respect to FIG. 5).

As described in detail below, client 10 can communicate with system 100, such as by interacting with a UI provided by system 100, where such interaction generates a clickstream. The clickstream can include a record of actions taken by the client 10 user in the UI, and is not necessarily limited to click events in all embodiments. For example, the clickstream can record events where a user clicked on a UI element, entered text into a UI field, or otherwise interacted with the UI.

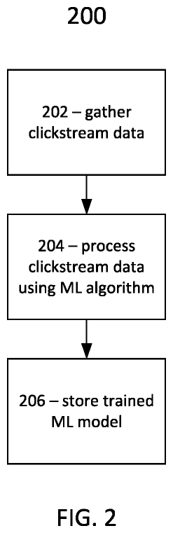

System 100 can include clickstream processing 110, which can generate the clickstream data by monitoring and recording user interactions with the UI. The clickstream data can be used by ML processing 120 to build and store ML model(s) 130 and/or to facilitate real-time processing 140. Real-time processing 140 can enable customization of UI elements at runtime in response to user actions in the clickstream data. Streamlined processing 150 can make decisions on UI elements without leveraging live clickstream data at runtime, for example to save processing time and/or reduce bandwidth use. Depending on the scenario, real-time processing 140 and/or streamlined processing 150 can influence UI elements generated and/or displayed by UI processing 160, for example by providing a UI to client 10 over a network. The functions and features of each system 100 element are described in greater detail below. For example, FIGS. 2-4 illustrate the functioning of the illustrated components in detail.

Elements illustrated in FIG. 1 (e.g., client 10 and/or system 100 including clickstream processing 110, ML processing 120, ML model 130, real-time processing 140, streamlined processing 150, and/or UI processing 160) are each depicted as single blocks for ease of illustration, but those of ordinary skill in the art will appreciate that these may be embodied in different forms for different implementations. For example, while clickstream processing 110, ML processing 120, ML model 130, real-time processing 140, streamlined processing 150, and/or UI processing 160 are depicted separately, any combination of these elements may be part of a combined hardware, firmware, and/or software element. Likewise, while clickstream processing 110, ML processing 120, ML model 130, real-time processing 140, streamlined processing 150, and/or UI processing 160 are depicted as parts of a single system 100, any combination of these elements may be distributed among multiple logical and/or physical locations. Also, while one client 10 and one system 100 are illustrated, this is for clarity only, and multiples of any of the above elements may be present. In practice, there may be single instances or multiples of any of the illustrated elements, and/or these elements may be combined or co-located.

System 100 can use a trained ML model to identify users likely to utilize a given UI resource, such as a self-help resource. Note that while self-help is used throughout this discussion as an example, it will be clear to those of ordinary skill that similar systems and methods can apply to any UI resources. In order to facilitate such identification, system 100 can train an ML model. FIG. 2 shows an example training process according to some embodiments of the disclosure, where the training can include gathering batch clickstream activity from a given time period and processing the batch clickstream activity with an ML algorithm.

At 202, system 100 can gather clickstream data. For example, clickstream processing 110 can monitor and record user interactions with a UI. In some embodiments, clickstream processing 110 can include a stream processing pipeline that reads all clickstream events and writes them to system 100 memory as a feature set. Clickstream events recorded by clickstream processing 110 can record one or more attributes of the interaction that describe the scenario (e.g., “view,” describing what is being displayed to the user by the UI; “action,” describing the click or other action taken by the user in the UI; and/or “screen,” describing the subset of the UI with which the user is engaging). In some cases, the stream processing pipeline can be targeted to record clickstream events for a certain subset of users or instances of the UI (e.g., in a financial accounting UI, only small business users' clickstreams may be monitored, or only individual users' clickstreams, etc.). Each write to the data service layer of system 100 may be serialized and fairly small (e.g., under 1 kb). Clickstream data can be gathered and/or stored for discrete ordered batches of time in some embodiments. Historic clickstream data gathered in this way can indicate a plurality of interactions with a UI by a plurality of users.

At 204, system 100 can process the clickstream data using an ML algorithm. For example, ML processing 120 can obtain the clickstream data from 202 and train an ML model 130 such as a classification model. In the embodiments where the clickstream data is stored as a feature set, ML processing 120 can make a call to system 100 data service layer to retrieve the feature set.

The clickstream data used as training data can include clickstreams of users who engaged with the UI resource of interest (e.g., self-help) and who did not. The clickstream data can include, for each user, clickstream actions taken and timestamps for those actions. Accordingly, the data will effectively be labeled through the inclusion of actions that constitute interactions with the UI resource of interest (e.g., clicks on a self-help interface). ML processing 120 can also retrieve user features for users whose clickstream data appears in the feature set. For example, each user can have an account, and ML processing 120 can obtain some or all account data for each user (e.g., biographical and/or demographic data).

ML processing 120 can leverage the users' clickstream data for a given period (e.g., starting from a given time for a clickstream timestamp to the present, or to a second time) and the users' features to train a classification model. The trained ML model 130 will be trained to predict users' likelihoods of UI resource access (e.g., self-help engagement) from last time stamp activity in the product.

At 206, system 100 can store the trained ML model in system 100 memory for subsequent use in predicting users likely to access the UI resource, as described in detail below.

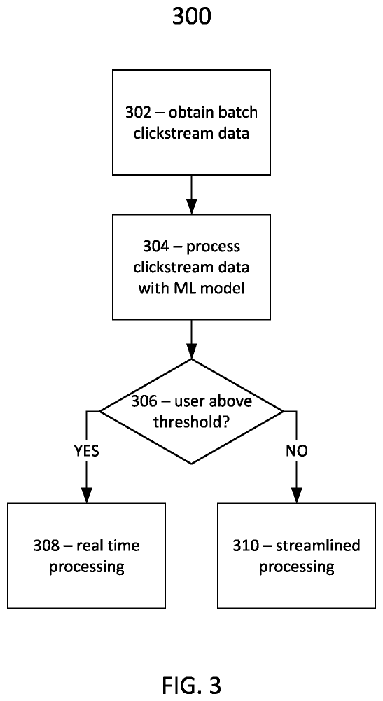

FIG. 3 shows an example processing decision process 300 according to some embodiments of the disclosure. System 100 can use process 300 to predict the likelihood of a user engaging with the UI resource and provision computing resources accordingly. This can include selecting at least one user for real-time monitoring and other user(s) for less computationally intensive processing.

At 302, system 100 can obtain batch clickstream data, such as historic clickstream data indicating a plurality of interactions with a UI by a plurality of users. For example, in the embodiments where the clickstream data is stored as a feature set, ML processing 120 can make a data fetch call to system 100 data service layer with a user's identifying information (e.g., user_id, company_id, etc.) to retrieve the user account's latest clickstream events as features to make a prediction.

At 304, system 100 can perform ML processing using the features obtained at 302. For example, ML processing 120 can process the features with the trained ML model 130 (e.g., historic clickstream data comprising a trained ML model trained on batch clickstream activity from a given time period).

Based on the output of the processing at 304, ML processing 120 can predict whether the user will utilize the UI resource. For example, at 306, system 100 can determine that the at least one user feature correlates with historic clickstream data for prior users of the UI resource. In some embodiments, this includes determining that an outcome of the processing indicates the user feature has a similarity to the historic clickstream data for the prior users of the UI resource above a threshold similarity level. Some embodiments may include a buffer zone from which users can be optionally selected for real-time processing as well. For example, if the threshold similarity level is 50% with a 5% buffer, users who are 46% similar can also be advanced to real-time processing.

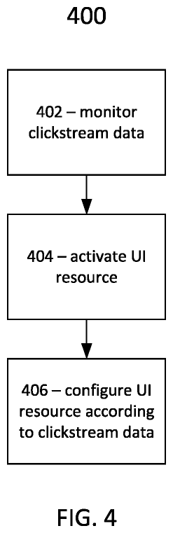

At 308, system 100 can perform real-time processing for users having a similarity above the threshold level or within the buffer zone. Examples of such real-time processing are described in detail with respect to FIG. 4 below.

At 310, system 100 can perform streamlined processing for users deemed less similar to historic users of the UI resource (e.g., those below the threshold level). For these users, streamlined processing 150 can provide a commonly-requested set of UI resource characteristics (e.g., self-help topics) or other default data to UI processing 160. UI processing 160 can therefore present the UI to client 10 without actively monitoring user clickstream to predict and pre-load characteristics of the UI resource (e.g., predict self-help topics relevant to the current UI state, so that when a user activates the self-help feature, the initially-surfaced topics are most relevant to the user's current work).

FIG. 4 shows an example real-time configuration process 400 according to some embodiments of the disclosure. System 100 can use process 400 to perform real-time processing for users predicted as likely to engage with the UI resource (for example, by process 300).

At 402, system 100 can monitor ongoing clickstream data of at least one user selected for real-time processing. For example, clickstream processing 110 can collect and store clickstreams for users identified for real-time processing (e.g., at 308 of process 300, as described above). That is, based on the prediction results, the predicted users' clickstream data are prioritized among all CG clickstream events for collection with the data processing pipeline. The processed clickstream data can be stored in system 100 memory. Clickstreams of users not identified for real-time processing need not be monitored and stored at runtime. Considering the volume of the clickstream data for multiple clients 10 interacting with system 100, and the real-time nature of the UI processing, any stored clickstream features can be purged over time (e.g., in approximately an hour after being written to the database in some embodiments).

At 404, system 100 can activate the UI resource. For example, UI processing 160 can be configured to receive commands issued by client 10 and receive a command to activate the UI resource (e.g., a selection of a self-help option). Alternatively or additionally, real-time processing 140 can detect an event activating the UI resource in the clickstream.

At 406, system 100 can configure the UI resource according to the ongoing clickstream data observed at 402. For example, real-time processing 140 can read latest clickstream data and retrieve UI resource elements associated with the latest clickstream data. The clickstream data can indicate the subject matter with which the user is engaged (e.g., an article topic or feature of the UI). System 100 memory may include one or more UI resource elements tagged, labeled, or otherwise organized according to subject matter (e.g., self-help topics). Accordingly, real-time processing can provide retrieved UI resource elements, linked to the subject matter with which the user is currently or most recently engaging, to UI processing 160. UI processing 160 can provide these retrieved UI resource elements to client 10 when requested or required (e.g., providing context-specific help in response to a user selecting a generic self-help option and not specifically requesting a particular help topic).

As discussed above, the processes 200, 300, 400 can be adapted to any type of UI experience. The following is a non-exhaustive example of one such use case, wherein the UI resource is a self-help option, and the overall UI is a tax preparation tool. In this case, the ML model can be trained by process 200 to predict the likelihood of a user engaging with self-help using customer account features. Doing this will help prioritize the clickstream sequences of the predicted users who need high availability support, thereby reducing the end-to-end clickstream traffic (e.g., from the raw clickstream source to the help file database).

At run time of process 300, the model can run in a batch job to predict likelihood of user engagement in the next 1 hour, 2 hours, and 3 hours. Process 300 can filter out users who will not engage with self-help and thus prioritize resources for users likely engaging in self-help.

In process 400, clickstream data of users predicted to engage with self-help can be leveraged to customize the UI, which benefits these users (e.g., encourages retention and customer satisfaction) while reducing the performance and bandwidth requirements of system 100 overall, which does not have to process all clickstream data of all users. Clickstream data is a source of rich custom features, both general (e.g., experimentation and segmentation identifiers) and specific (e.g., W2 import attributes). Such clickstream data can useful for predicting customer behaviors for a variety of use cases. For example, a self-help query-less search model can get features from a real-time data pipeline that reads from the raw clickstream. The model then can make predictions based on a user's past actions (e.g., past 30 in-product clicks). In some embodiments, this query-less search model reduced the escalation rate to a live help agent by 15% and reduced cancellation rate by 20%. However, in tests of some UI systems, less than 5% of all users interact with self-help. By proactively identifying and prioritizing these hotspot users, the embodiments discussed above can reduce the traffic that reaches the data storage layer, thereby reducing the load to the data infrastructure and the risks and costs incurred.

FIG. 5 shows a computing device 500 according to some embodiments of the disclosure. For example, computing device 500 may function as system 100 and/or client 10, and/or any portion(s) thereof, or multiple computing devices 500 may function as any of system 100 and/or client 10.

Computing device 500 may be implemented on any electronic device that runs software applications derived from compiled instructions, including without limitation personal computers, servers, smart phones, media players, electronic tablets, game consoles, email devices, etc. In some implementations, computing device 500 may include one or more processors 502, one or more input devices 504, one or more display devices 506, one or more network interfaces 508, and one or more computer-readable mediums 510. Each of these components may be coupled by bus 512, and in some embodiments, these components may be distributed among multiple physical locations and coupled by a network.

Display device 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device 504 may be any known input device technology, including but not limited to a keyboard (including a virtual keyboard), mouse, track ball, and touch-sensitive pad or display. Bus 512 may be any known internal or external bus technology, including but not limited to ISA, EISA, PCI, PCI Express, NuBus, USB, Serial ATA or FireWire. In some embodiments, some or all devices shown as coupled by bus 512 may not be coupled to one another by a physical bus, but by a network connection, for example. Computer-readable medium 510 may be any medium that participates in providing instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 510 may include various instructions 514 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Network communications instructions 516 may establish and maintain network connections (e.g., software for implementing communication protocols, such as TCP/IP, HTTP, Ethernet, telephony, etc.).

Intelligent routing 518 may include the system elements and/or the instructions that enable computing device 500 to perform the processing of any and/or all elements of system 100 as described above. For example, intelligent routing 518 may include instructions for performing any and/or all of processes 200, 300, and/or 400. Application(s) 520 may be an application that uses or implements the outcome of processes described herein and/or other processes. In some embodiments, the various processes may also be implemented in operating system 514.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Additionally or alternatively, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method comprising:
obtaining, by a processor, historic clickstream data indicating a plurality of interactions with a user interface (UI) by a plurality of users;
selecting, by the processor, at least one user from among the plurality of users for real-time monitoring, the selecting including:
processing, using a machine learning (ML) model, the historic clickstream data and at least one user feature, and
predicting, from the processing, that the at least one user will utilize a UI resource, the predicting comprising determining that the plurality of interactions indicated by the historic clickstream data are similar to the at least one user feature above a threshold similarity, wherein at least one additional user from among the plurality of users is predicted to not utilize the UI resource and is therefore not selected for the real-time monitoring;
monitoring, by the processor, ongoing clickstream data of the selected at least one user; and
configuring, by the processor, the UI resource for the selected at least one user according to a subject matter with which the user is engaged as indicated by the ongoing clickstream data, the configuring comprising identifying at least one UI element that corresponds to the subject matter and integrating the at least one UI element into the UI resource at a time when the user is engaged with the subject matter,
wherein, for the at least one additional user, the processor performs streamlined processing including configuring the UI resource for the at least one additional user to include default data not reliant on real-time monitoring.

2. The method of claim 1, wherein the UI resource includes a help interface.

3. The method of claim 2, wherein the configuring the UI resource comprises selecting at least one help element related to the ongoing clickstream data and, in response to receiving a generic command to access the help interface, presenting the at least one help element.

4. The method of claim 1, wherein the historic clickstream data comprises a trained ML model trained on batch clickstream activity from a given time period.

5. (canceled)

6. (canceled)

7. The method of claim 1, further comprising training, by the processor, the ML model, the training comprising gathering batch clickstream activity from a given time period and processing the batch clickstream activity with an ML algorithm.

8. A method comprising:
obtaining, by a processor, batch clickstream activity including historic clickstream data indicating a plurality of interactions with a user interface (UI) by a plurality of users;
determining, by the processor, one or more respective attributes of respective ones of the plurality of interactions, wherein the one or more respective attributes indicate whether an interaction involved a UI resource or did not involve the UI resource;
training, by the processor, a machine learning (ML) model, the training comprising processing at least the one or more respective attributes with an ML algorithm;
predicting, by the processor, that at least one user of the plurality of users will utilize the UI resource, the predicting comprising determining that the one or more respective attributes are similar to at least one user feature above a threshold similarity, wherein at least one additional user from among the plurality of users is predicted to not utilize the UI resource; and
configuring, by the processor, the UI resource to correspond with a subject matter with which the user is engaged as indicated by observed user activity in the UI for the at least one user predicted to utilize the UI resource, the configuring comprising identifying at least one UI element that corresponds to the subject matter and integrating the at least one UI element into the UI resource at a time when the user is engaged with the subject matter,
wherein, for the at least one additional user, the processor performs streamlined processing including configuring the UI resource for the at least one additional user to include default data not reliant on real-time monitoring.

9. The method of claim 8, wherein the UI resource includes a help interface.

10. The method of claim 9, wherein the configuring the UI resource comprises selecting at least one help element related to ongoing clickstream data of the user and, in response to receiving a generic command to access the help interface, presenting the at least one help element.

11. (canceled)

12. (canceled)

13. The method of claim 8, further comprising obtaining, by the processor, the observed user activity in the UI, the obtaining comprising monitoring ongoing clickstream data of the at least one user.

14. A system comprising:
a processor; and
a non-transitory memory in communication with the processor storing instructions that, when executed by the processor, cause the processor to perform processing comprising:
obtaining historic clickstream data indicating a plurality of interactions with a user interface (UI) by a plurality of users;
selecting at least one user from among the plurality of users for real-time monitoring, the selecting including:
processing, using a machine learning (ML) model, the historic clickstream data and at least one user feature, and
predicting, from the processing of the historic clickstream data and the at least one user feature, that the at least one user will utilize a UI resource, the predicting comprising determining that the plurality of interactions indicated by the historic clickstream data are similar to the at least one user feature above a threshold similarity, wherein at least one additional user from among the plurality of users is predicted to not utilize the UI resource and is therefore not selected for the real-time monitoring;
monitoring ongoing clickstream data of the selected at least one user; and
configuring the UI resource for the at least one user according to a subject matter with which the user is engaged as indicated by the ongoing clickstream data, the configuring comprising identifying at least one UI element that corresponds to the subject matter and integrating the at least one UI element into the UI resource at a time when the user is engaged with the subject matter,
wherein, for the at least one additional user, the processor is configured to perform streamlined processing including configuring the UI resource for the at least one additional user to include default data not reliant on real-time monitoring.

15. The system of claim 14, wherein the UI resource includes a help interface.

16. The system of claim 15, wherein the configuring the UI resource comprises selecting at least one help element related to the ongoing clickstream data and, in response to receiving a generic command to access the help interface, presenting the at least one help element.

17. The system of claim 14, wherein the historic clickstream data comprises a trained ML model trained on batch clickstream activity from a given time period.

18. (canceled)

19. (canceled)

20. The system of claim 14, wherein the processing further comprises training the ML model, the training comprising gathering batch clickstream activity from a given time period and processing the batch clickstream activity with an ML algorithm.

21. The method of claim 1, further comprising presenting the UI resource in response to a user request.

22. The method of claim 8, further comprising presenting the UI resource in response to a user request.

23. The system of claim 14, wherein the processing further comprises presenting the UI resource in response to a user request.
